(19) United States
(12) Patent Application Publication
(10) Pub. No.: US 2011/0045286 A1
(43) Pub. Date: Feb. 24, 2011

(54) Pressure-sensitive adhesive tape for fixing a honeycomb core during cutting operation

(75) Inventors: Hiroyuki Watanabe, Ibaraki-shi (JP); Naoki Nakayama, Ibaraki-shi (JP)

Correspondence Address: EDWARDS ANGELL PALMER & DODGE LLP, P.O. BOX 55874, BOSTON, MA, 02205, US

(73) Assignee: NITTO DENKO CORPORATION, Ibaraki-Shi (JP)

(21) Appl. No.: 12/805,716

(22) Filed: Aug. 16, 2010

(30) Foreign Application Priority Data
Aug. 18, 2009 (JP) JP2009-188910

(51) Int. Cl. C09J 7/02

(52) U.S. Cl. 428/343

(57) ABSTRACT

An object of the present invention is to provide a pressure-sensitive adhesive tape for fixing a honeycomb core during cutting operation superior in cutting operability that can fix the honeycomb core without dislocation or separation during cutting operation and can be removed without fracture of the honeycomb core or adhesive deposit after cutting operation. The pressure-sensitive adhesive tape for fixing a honeycomb core during cutting operation according to the present invention is a pressure-sensitive adhesive tape including a base and an pressure-sensitive adhesive layer formed on at least one face of the base, having a cleavage adhesive strength of 10 to 80 N/400 mm², a shear adhesive strength of 100 to 700 N/400 mm², a breaking strength in the machine direction (MD) of 30 to 200 N/10 mm, and a breaking strength in the transverse direction (TD) of 30 to 200 N/10 mm.

### TECHNICAL FIELD

The present invention relates to a pressure-sensitive adhesive tape. Specifically, it relates to a pressure-sensitive adhesive tape that is used for fixation of a honeycomb core during cutting operation.

### BACKGROUND ART

Honeycomb cores have been used widely, for example, as core materials for sandwich panels, and such sandwich panels have been used widely as various structural materials for airplane bodies and the like because of their superior strength-to-weight ratio. As for the method of producing such a honeycomb core, a method of fixing a honeycomb core on a table of an operating machine by using a double-sided pressure-sensitive adhesive tape and machine-operating the same is known. Also, a method of filling microparticulate nonmetal particles into the cells of the honeycomb core and cutting operation the same is known (see Patent Document 1).

However, the operating method above often lead to a problem of operation defects caused by dislocation and separation of the honeycomb core from a particular position, due to the stress generated when a cutter blade touches the honeycomb core. The pressure-sensitive adhesive tape used for fixation should be removed from the honeycomb core after cutting operation of the honeycomb core, but there were also problems such as fracture of the honeycomb core and adhesive deposit (phenomenon of part of the pressure-sensitive adhesive tape remaining on the honeycomb core) during separation. For this reason, recently there has been a need for a pressure-sensitive adhesive tape for fixing a honeycomb core during cutting operation that does not cause such problems and is superior in cutting operability.

### CITATION LIST

### Patent Literature

Patent Document 1: Japanese Unexamined Patent Application Publication (JP-A) No. H6 (1994)-179195

### SUMMARY OF INVENTION

### Technical Problem

Accordingly, an object of the present invention is to provide a pressure-sensitive adhesive tape for fixing a honeycomb core during cutting operation superior in cutting operability that can fix a honeycomb core without dislocation or separation during cutting operation and can be removed without fracture of the honeycomb core or adhesive deposit after cutting operation.

### Solution to Problem

After intensive studies to solve the problems above, the inventors have found that it was possible to obtain a pressure-sensitive adhesive tape superior in honeycomb core-cutting operability by controlling the cleavage adhesive strength, the shear adhesive strength, the breaking strength in the machine direction (MD) and the breaking strength in the transverse direction (TD) of a pressure-sensitive adhesive tape having a base and a pressure-sensitive adhesive layer formed on at least one face side of the base in particular ranges. The present invention was made based on these findings.

Thus, the present invention provides a pressure-sensitive adhesive tape for fixing a honeycomb core during cutting operation including a base, and a pressure-sensitive adhesive layer formed on at least one face of the base, and having a cleavage adhesive strength of 10 to 80 N/400 mm² measured by the following cleavage adhesive strength test, a shear adhesive strength of 100 to 700 N/400 mm², a breaking strength in the machine direction (MD) of 30 to 200 N/10 mm, and a breaking strength in the transverse direction (TD) of 30 to 200 N/10 mm. The cleavage adhesive strength test is performed in the following manner: A surface of the pressure-sensitive adhesive layer of a pressure-sensitive adhesive tape (size: 20 mm×20 mm, area: 400 mm²) is bonded to an end of a SUS plate (a) (size: width 30 mm×length 80 mm, thickness: 2.0 mm) in the longitudinal direction, and the opposite face side of the pressure-sensitive adhesive tape to the side bonded to the SUS plate (a) is fixed to a SUS plate (b), to give a test sample; the load applied when the pressure-sensitive adhesive tape is peeled off is determined, as the SUS plate (b) is fixed and an end of the SUS plate (a) in the longitudinal direction opposite to that bonded to the pressure-sensitive adhesive tape is pulled in a direction perpendicular to the surface of the SUS plate (b) at a speed of 300 mm/minute.

The present invention also provides the pressure-sensitive adhesive tape for fixing a honeycomb core during cutting operation, wherein the base is a plastic film.

The present invention also provides the pressure-sensitive adhesive tape for fixing a honeycomb core during cutting operation, wherein an adhesive forming the pressure-sensitive adhesive layer is an acrylic adhesive.

The present invention further provides the pressure-sensitive adhesive tape for fixing a honeycomb core during cutting operation, wherein the pressure-sensitive adhesive layer is a pressure-sensitive adhesive layer formed by irradiation of active energy ray.

### ADVANTAGEOUS EFFECTS OF INVENTION

The pressure-sensitive adhesive tape for fixing a honeycomb core during cutting operation according to the present invention, which has a cleavage adhesive strength, a shear adhesive strength, a breaking strength in the machine direction (MD) and a breaking strength in the transverse direction (TD) in particular ranges, can fix a honeycomb core without dislocation or separation of the honeycomb core during cutting operation. In addition, the pressure-sensitive adhesive tape can be peeled off without fracture of the honeycomb core or adhesive deposit after cutting operation. Thus the pressure-sensitive adhesive tape for fixing a honeycomb core during cutting operation according to the present invention improves the cutting operability and also the productivity of honeycomb cores.

### BRIEF DESCRIPTION OF DRAWINGS

FIG. 1 is a schematic view (top view) illustrating a test sample used in measurement of the cleavage adhesive strength in Examples.

FIG. 2 is a schematic view (A-A cross-sectional view) of the test sample hooked with an S-shaped hook used in measurement of the cleavage adhesive strength in Examples.

FIG. 3 is a schematic view (top view) illustrating the test sample used in measurement of the shear adhesive strength in Examples.

FIG. 4 is a schematic view (B-B cross-sectional view) illustrating the test sample used in measurement of the shear adhesive strength in Examples.

### DESCRIPTION OF EMBODIMENTS

Hereinafter, preferred embodiments of the present invention will be described in detail.

A pressure-sensitive adhesive tape for fixing a honeycomb core during cutting operation according to the present invention (hereinafter, referred to as “the pressure-sensitive adhesive tape according to the present invention”) is a pressure-sensitive adhesive tape having a base and a pressure-sensitive adhesive layer formed on at least one face of the base, wherein: the cleavage adhesive strength of the pressure-sensitive adhesive tape is 10 to 80 N/400 mm²; the shear adhesive strength thereof is 100 to 700 N/400 mm²; and the breaking strength in the machine direction (MD) and the breaking strength in the transverse direction (TD) are both 30 to 200 N/10 mm. In the present invention, the machine direction (MD) is the direction of the production line in production process (flow direction) and, in the case of long tape, it is the direction of the length of the tape. Alternatively, the transverse direction (TD) is the direction perpendicular to the MD direction above and means the direction of the width of the tape.

The pressure-sensitive adhesive tape according to the present invention may be, for example, a double sided pressure-sensitive adhesive tape in a configuration having pressure-sensitive adhesive layers on both sides of the base or a single-sided pressure-sensitive adhesive tape in a configuration having a pressure-sensitive adhesive layer only on one side of the base. The “pressure-sensitive adhesive tapes”, as used in the present invention, include sheet-shaped products, i.e., “pressure-sensitive adhesive sheets”. In addition, the surface of the pressure-sensitive adhesive layer may be referred to as “adhesive face”.

The pressure-sensitive adhesive tape according to the present invention is used in fixing a honeycomb core on a table of an operating machine during cutting operation of the honeycomb core. When the pressure-sensitive adhesive tape according to the present invention is a double-sided pressure-sensitive adhesive tape, a honeycomb core is fixed, for example, as the honeycomb core is bonded to an adhesive face (pressure-sensitive adhesive layer surface) and an air-tight sheet material is bonded to the other adhesive face (pressure-sensitive adhesive layer surface), and then the sheet material is adsorbed on the operating machine under vacuum. When the pressure sensitive adhesive tape according to the present invention is a double-side pressure-sensitive adhesive tape, the pressure-sensitive adhesive layer bonded to the honeycomb core will be referred to as “honeycomb core-side pressure-sensitive adhesive layer” and the pressure-sensitive adhesive layer located to the side of the operating machine as “operating machine-sided pressure-sensitive adhesive layer”. Alternatively when the pressure-sensitive adhesive tape according to the present invention is a single-sided pressure-sensitive adhesive tape, a honeycomb core is fixed, for example, as the honeycomb core is bonded to an adhesive face (pressure-sensitive adhesive layer surface) and the base surface opposite to the adhesive face is adsorbed on the operating machine under vacuum.

### [Pressure-Sensitive Adhesive Layer]

The kind of the adhesive used for forming the pressure-sensitive adhesive layer in the pressure-sensitive adhesive tape according to the present invention is not particularly limited and, for example, a known adhesive such as acrylic adhesive, rubber-based adhesive, vinyl alkylether-based adhesive, silicone-based adhesive, polyester-based adhesive, polyamide-based adhesive, urethane-based adhesive, fluorine-based adhesive, epoxy-based adhesive or the like may be used. These adhesives may be used alone or in combination of two or more. The adhesive may be an adhesive in any form and, for example, an emulsion-type adhesive, a solvent-type (solution-type) adhesive, an active energy ray-curing adhesive, and a heat-fusing adhesive (hot melt-type adhesive) may be used. Among the adhesives above, use of an active energy ray-curing adhesive is preferable.

Among the adhesives above, the adhesive for forming the pressure-sensitive adhesive layer in the pressure-sensitive adhesive tape according to the present invention is preferably an acrylic adhesive. Thus, the pressure-sensitive adhesive layer in the pressure-sensitive adhesive tape according to the present invention is preferably an acrylic pressure-sensitive adhesive layer. The acrylic pressure-sensitive adhesive layer is a pressure-sensitive adhesive layer containing, as its base polymer, an acrylic polymer formed by using an acrylic monomer as essential monomer component. The content of the acrylic polymer (or acrylic polymer components) in the acrylic pressure-sensitive adhesive layer is preferably 65 wt % (percent by weight) or more (for example, 65 to 100 wt %), and more preferably 70 to 99.999 wt %, although it is not particularly limited thereto.

The acrylic pressure-sensitive adhesive layer may vary according to the method of forming the pressure-sensitive adhesive layer and is formed, for example, by using an acrylic pressure-sensitive adhesive composition containing an acrylic polymer as essential component or an acrylic pressure-sensitive adhesive composition containing a mixture of acrylic polymer-forming monomers (referred to as “monomer mixture”) or the partial polymer thereof as essential components, though it is not particularly limited thereto. Examples of the former compositions include so-called solvent-type pressure-sensitive adhesive compositions, and examples of the latter compositions include so-called active energy ray-curing pressure-sensitive adhesive compositions and the like, although they are not limited thereto. The pressure-sensitive adhesive composition may contain, as needed, a crosslinking agent and various other additives.

The term “pressure-sensitive adhesive composition” also includes a concept of a “composition for forming a pressure-sensitive adhesive layer”. The “monomer mixture” means a mixture of only monomer components forming the acrylic polymer. The “partial polymer” means a composition in which one or two of the components in the monomer mixture above are partially polymerized.

The acrylic polymer is preferably an acrylic polymer formed from a linear- or branched-chain alkyl group-containing alkyl (meth)acrylates as the essential monomer component. The term “(meth)acrylic” above means “acrylic” and/or “methacrylic” and the same is true for other descriptions.

The monomer component for forming the acrylic polymer may contain polar group-containing monomers, polyfunctional monomers, and other copolymerizable monomers as copolymerization monomer components. Use of the copolymerization monomer components can improve, for example, the adhesive strength to an adherend and increase the cohesive power of the pressure-sensitive adhesive layer. These copolymerization monomer components may be used alone or in combination of two or more.

Examples of the straight- or branched-chain alkyl group-containing alkyl (meth)acrylates (hereinafter, referred to simply as “alkyl (meth)acrylates”) include alkyl (meth)acrylates with an alkyl group having 1 to 20 carbon atoms such as methyl (meth)acrylates, ethyl (meth)acrylates, propyl (meth)acrylates, isopropyl (meth)acrylates, n-butyl (meth)acrylates, isobutyl (meth)acrylates, s-butyl (meth)acrylates, t-butyl (meth)acrylates, pentyl (meth)acrylates, isopentyl (meth)acrylates, hexyl (meth)acrylates, heptyl (meth)acrylates, octyl (meth)acrylates, 2-ethylhexyl (meth)acrylates, isooctyl (meth)acrylates, nonyl (meth)acrylates, isononyl (meth)acrylates, decyl (meth)acrylates, isodecyl (meth)acrylates, undecyl (meth)acrylates, dodecyl (meth)acrylates, tridecyl (meth)acrylates, tetradecyl (meth)acrylates, pentadecyl (meth)acrylates, hexadecyl (meth)acrylates, heptadecyl (meth)acrylates, octadecyl (meth)acrylates, nonadecyl (meth)acrylates, and eicosyl (meth)acrylates. Among them, alkyl (meth)acrylates with an alkyl group having 2 to 14 carbon atoms are preferable, alkyl (meth)acrylates with an alkyl group having 2 to 10 carbon atoms are more preferable, and isononyl acrylate, isononyl methacrylate and isooctyl acrylate are particularly preferable. The alkyl (meth)acrylates may be used alone or in combination of two or more.

The alkyl (meth)acrylates are used as the essential monomer component of the acrylic polymer, and the content of the alkyl (meth)acrylates is preferably 50 to 100 wt %, more preferably 60 to 99.9 wt %, with respect to total amount of the acrylic polymer-forming monomers (100 wt %).

Examples of the polar group-containing monomers include carboxyl group-containing monomers such as (meth)acrylic acids, itaconic acid, maleic acid, fumaric acid, crotonic acid, and isocrotonic acid; or the anhydrides thereof (such as maleic anhydride); hydroxyl group-containing monomers including hydroxyalkyl (meth)acrylates such as 2-hydroxyethyl (meth)acrylates, 3-hydroxypropyl (meth)acrylates, 4-hydroxybutyl (meth)acrylates and 6-hydroxyhexyl (meth)acrylates, vinyl alcohols and allyl alcohols; amide group-containing monomers such as (meth)acrylamides, N,N-dimethyl(meth)acrylamides, N-methylol (meth)acrylamides, N-methoxymethyl(meth)acrylamides, N-butoxymethyl(meth)acrylamides, and N-hydroxyethylacrylamide; amino-group-containing monomers such as aminoethyl (meth)acrylates, dimethylaminoethyl (meth)acrylates and t-butylaminoethyl (meth)acrylates; glycidyl group-containing monomers such as glycidyl (meth)acrylates, and methylglycidyl (meth)acrylates; cyano group-containing monomers such as acrylonitrile, and methacrylonitrile; heterocycle-containing vinyl monomers such as N-vinyl-2-pyrrolidone, (meth)acryloylmorpholines, N-vinylpyridine, N-vinylpiperidone, N-vinylpyrimidine, N-vinylpiperazine, N-vinylpyrrole, N-vinylimidazole, and N-vinyloxazole; alkoxyalkyl (meth)acrylate-based monomers such as methoxyethyl (meth)acrylates, and ethoxyethyl (meth)acrylates; sulfo-containing monomers such as sodium vinylsulfonate; phosphate containing monomers such as 2-hydroxyethyl acryloyl phosphate; imide group-containing monomers such as cyclohexylmaleimide and isopropylmaleimide; isocyanate group-containing monomers such as 2-methacryloyloxyethyl isocyanate; and the like. Among the monomers above, the polar group-containing monomer is preferably a carboxyl group-containing monomer or a hydroxyl group-containing monomer, and more preferably acrylic acid or 4-hydroxybutyl acrylate. The polar group-containing monomers may be used alone or in combination of two or more.

The content of the polar group-containing monomer is preferably 1 to 30 wt %, more preferably 3 to 20 wt %, with respect to the total amount of the acrylic polymer-forming monomer components (100 wt %). A polar group-containing monomer content of more than 30 wt % may result in decrease in tackiness of the pressure-sensitive adhesive layer due to excessive increase in cohesive power of the pressure-sensitive adhesive layer and deterioration of the cutting operability of the honeycomb core because of difficulty in obtaining high cleavage adhesive strength. Meanwhile, a polar group-containing monomer content of less than 1 wt % may result in deterioration of the cutting operability of the honeycomb core because of deterioration in cohesive power of the pressure-sensitive adhesive layer and failure to have high shear adhesive strength, possibly leading to generation of adhesive deposit when the honeycomb core is peeled off.

Examples of the polyfunctional monomers include hexanediol di(meth)acrylates, butanediol di(meth)acrylates, (poly)ethylene glycol di(meth)acrylates, (poly)propylene glycol di(meth)acrylates, neopentylglycol di(meth)acrylates, pentaerythritol di(meth)acrylates, pentaerythritol tri(meth)acrylates, dipentaerythritol hexa(meth)acrylates, trimethylolpropane tri(meth)acrylates, tetramethylolmethane tri(meth)acrylates, allyl (meth)acrylates, vinyl (meth)acrylates, divinylbenzene, epoxy acrylates, polyester acrylates, urethane acrylates, and the like.

The content of the polyfunctional monomer is preferably 0.5 wt % or less (for example, 0 to 0.5 wt %), and more preferably, 0 to 0.3 wt %, with respect to the total amount of the acrylic polymer-forming monomer components (100 wt %). A polyfunctional monomer content of more than 0.5 wt % may lead to deterioration of the tackiness of the pressure-sensitive adhesive layer due to excessive increase in cohesive power of the pressure-sensitive adhesive layer and failure to have high cleavage adhesive strength. The polyfunctional monomer may not be used, if a crosslinking agent is used, but, if no crosslinking agent is used, the content of the polyfunctional monomer is preferably 0.001 to 0.5 wt %, more preferably 0.002 to 0.1 wt %.

Examples of the copolymerizable monomers other than the polar group-containing monomers and the polyfunctional monomers include alicyclic hydrocarbon group-containing (meth)acrylates such as cyclopentyl (meth)acrylates, cyclohexyl (meth)acrylates and isobornyl (meth)acrylates; aryl (meth)acrylates such as phenyl (meth)acrylates; vinyl esters such as vinyl acetate, and vinyl propionate; aromatic vinyl compounds such as styrene, and vinyltoluene; olefins or dienes such as ethylene, butadiene, isoprene, and isobutylene; vinyl ethers such as vinyl alkylethers; and vinyl chloride.

The acrylic polymer described above can be prepared by polymerization of the monomer components by a known common polymerization method. Examples of the polymerization methods for the acrylic polymer include solution polymerization, emulsion polymerization, bulk polymerization, active energy ray-irradiation polymerization (active energy ray polymerization), and the like. Among them, the solution polymerization method and the active energy ray polymerization method are preferable, because it is possible to thicken the pressure-sensitive adhesive layer. As will be described below, it is desirable to make the pressure-sensitive adhesive layer thicker than a particular thickness in order to fix the honeycomb core without dislocation or separation during cutting operation. Thus the active energy ray polymerization (also called photopolymerization) method is more preferable because it is possible to produce a thicker pressure-sensitive adhesive layer and raise the shear adhesive strength of the pressure-sensitive adhesive layer effectively. In particular, an ultraviolet polymerization method with UV irradiation is preferable.

Examples of the active energy rays irradiated during the active energy ray polymerization (photopolymerization) include ionizing radiation such as α ray, β ray, γ ray, neutron beam, and electron beam, ultraviolet ray, and ultraviolet ray is particularly preferable. The irradiation energy, the exposure period, the irradiation method and others of the active energy ray are not particularly limited, if it can activate the photopolymerization initiator, initiating the reaction of the monomer components.

Various common solvents can be used during the solution polymerization. Examples of the solvents include organic solvents including esters such as ethyl acetate and n-butyl acetate; aromatic hydrocarbons such as toluene and benzene; aliphatic hydrocarbons such as n-hexane and n-heptane; alicyclic hydrocarbons such as cyclohexane and methylcyclohexane; and ketones such as methylethylketone and methylisobutylketone. The solvents may be used alone or in combination of two or more.

In preparation of the acrylic polymer above, a polymerization initiator such as a photopolymerization initiator (photoinitiator) or a thermal polymerization initiator may be used according to the kind of the polymerization reaction. The polymerization initiators may be used alone or in combination of two or more.

Examples of the photopolymerization initiator include, but are not particularly limited to, benzoin ether-based photopolymerization initiators, acetophenone-based photopolymerization initiators, α-ketol-based photopolymerization initiators, aromatic sulfonyl chloride-based photopolymerization initiators, optically active oxime-based photopolymerization initiators, benzoin-based photopolymerization initiators, benzyl-based photopolymerization initiators, benzophenone-based photopolymerization initiators, ketal-based photopolymerization initiators, thioxanthone-based photopolymerization initiators, and the like. The amount of the photopolymerization initiator added is not particularly limited but, for example, preferably 0.01 to 0.2 parts by weight, and more preferably 0.05 to 0.15 parts by weight, with respect to the total amount of the acrylic polymer-forming monomer components (100 parts by weight).

Examples of the benzoin ether-based photopolymerization initiators include benzoin methylether, benzoin ethylether, benzoin propylether, benzoin isopropylether, benzoin isobutylether, 2,2-dimethoxy-1,2-diphenylethan-1-one, anisole methylether, and the like. Examples of the acetophenone-based photopolymerization initiators include 2,2-diethoxyacetophenone, 2,2-dimethoxy-2-phenylacetophenone, 1-hydroxycyclohexylphenylketone, 4-phenoxydichloroacetophenone, 4-(t-butyl)dichloroacetophenone, and the like. Examples of the α-ketol-based photopolymerization initiators include 2-methyl-2-hydroxypropiophenone, 1-[4-(2-hydroxyethyl)phenyl]-2-methylpropan-1-one and the like. Examples of the aromatic sulfonyl chloride-based photopolymerization initiators include 2-naphthalenesulfonyl chloride, and the like. Examples of the optically active oxime-based photopolymerization initiators include 1-phenyl-1,1-propandione-2-(o-ethoxycarbonyl)-oxime, and the like. Examples of the benzoin-based photopolymerization initiators include benzoin and the like. Examples of the benzyl-based photopolymerization initiator include benzyl, and the like. Examples of the benzophenone-based photopolymerization initiators include benzophenone, benzoylbenzoic acid, 3,3′-dimethyl-4-methoxybenzophenone, polyvinylbenzophenone, α-hydroxycyclohexylphenylketone, and the like. Examples of the ketal-based photopolymerization initiators include benzyldimethylketal, and the like. Examples of the thioxanthone-based photopolymerization initiators include thioxanthone, 2-chlorothioxanthone, 2-methylthioxanthone, 2,4-dimethylthioxanthone, isopropylthioxanthone, 2,4-diisopropylthioxanthone, dodecylthioxanthone, and the like.

Examples of the polymerization initiators used when the acrylic polymer is prepared by solution polymerization include azo-based initiators, peroxide-based polymerization initiators (such as dibenzoyl peroxide and tert-butyl permaleate), redox-based polymerization initiators, and the like. Among them, the azo-based initiators disclosed in Japanese Unexamined Patent Application Publication (JP-A) No. 2002-69411 are particularly preferable. These azo-based initiators are preferable because the decomposition products of the initiator are less likely to remain in the acrylic polymer as a component causing outgassing (outgassing induced by heating). Examples of the azo-based initiators include 2,2′-azobisisobutylonitrile (hereinafter, referred to as AIBN), 2,2′-azobis-2-methylbutylonitrile (hereinafter, referred to as AMBN), dimethyl 2,2′-azobis(2-methylpropionate), 4,4′-azobis-4-cyanovaleric acid, and the like. The amount of the azo-based initiator used is preferably 0.05 to 0.5 parts by weight, and more preferably 0.1 to 0.3 parts by weight with respect to the total amount of the acrylic polymer-forming monomer components (100 parts by weight).

The weight-average molecular weight of the acrylic polymer is preferably 300,000 to 2,000,000, more preferably 600,000 to 1,500,000, and still more preferably 700,000 to 1,500,000. When the weight-average molecular weight of the acrylic polymer is smaller than 300,000, the pressure-sensitive adhesive tape may not show favorable adhesion properties, resulting in displacement or separation of the honeycomb core during cutting operation, and on the other hand when it is more than 2000,000, there may be generated a problem in coatability. The weight-average molecular weight can be controlled by adjustment of the kind and the used amount of the polymerization initiator, the temperature and the period of polymerization, the monomer concentration, the drip rate of monomer added, or the like.

Known additives such as crosslinking agents, crosslinking accelerators, tackifiers (such as rosin-derived resins, polyterpene resins, petroleum resins, and oil-soluble phenol resins), aging inhibitors, fillers, colorants (pigments, dyes etc.), ultraviolet absorbents, antioxidants, chain-transfer agents, plasticizers, softeners, surfactants, and antistatic agents may be added as needed to the pressure-sensitive adhesive layer of the pressure-sensitive adhesive tape according to the present invention, in the range that does not impair the advantageous properties of the present invention. In addition, various general solvents may be used in preparation of the pressure-sensitive adhesive layer. The kind of the solvent is not particularly limited, and the solvents exemplified for use in solution polymerization described above may be used.

The gel fraction of the pressure-sensitive adhesive layer can be controlled by crosslinking the base polymer (for example, acrylic polymer above) of the pressure-sensitive adhesive layer with a crosslinking agent. Examples of the crosslinking agents include isocyanate-based crosslinking agents, epoxy-based crosslinking agents, melamine-based crosslinking agents, peroxide-based crosslinking agents, urea-based crosslinking agents, metal alkoxide-based crosslinking agents, metal chelate-based crosslinking agents, metal salt-based crosslinking agents, carbodiimide-based crosslinking agents, oxazoline-based crosslinking agents, aziridine-based crosslinking agents, amine-based crosslinking agents, and the like, and isocyanate-based crosslinking agents and epoxy-based crosslinking agents are used preferably. The crosslinking agents may be used alone or in combination of two or more.

Examples of the isocyanate-based crosslinking agents include lower aliphatic polyisocyanates such as 1,2-ethylene diisocyanate, 1,4-butylene diisocyanate and 1,6-hexamethylene diisocyanate; alicyclic polyisocyanates such as cyclopentylene diisocyanate, cyclohexylene diisocyanate, isophorone diisocyanate, hydrogenated tolylene diisocyanate, and hydrogenated xylene diisocyanate; aromatic polyisocyanates such as 2,4-tolylene diisocyanate, 2,6-tolylene diisocyanate, 4,4′-diphenylmethane diisocyanate, and xylylene diisocyanate, and in addition, a trimethyloipropaneltolylene diisocyanate adduct [trade name “CORONATE L”, produced by Nippon Polyurethane Industry Co., Ltd.], a trimethylolpropane/hexamethylene diisocyanate adduct [trade name “CORONATE HL”, produced by Nippon Polyurethane Industry Co., Ltd.] and the like are also used.

Examples of the epoxy-based crosslinking agents include N,N,N′,N′-tetraglycidyl-m-xylenediamine, diglycidylaniline, 1,3-bis(N,N-diglycidylaminomethyl)cyclohexane, 1,6-hexanediol diglycidylether, neopentylglycol diglycidylether, ethylene glycol diglycidylether, propylene glycol diglycidylether, polyethylene glycol diglycidylether, polypropylene glycol diglycidylether, sorbitol polyglycidylether, glycerol polyglycidylether, pentaerythritol polyglycidylether, polyglycerol polyglycidylether, sorbitan polyglycidylether, trimethylolpropane polyglycidylether, diglycidyl adipate, diglycidyl o-phthalate, triglycidyl-tris(2-hydroxyethyl)isocyanurate, resorcin diglycidylether, bisphenol-5-diglycidylether, epoxy resins having two or more epoxy groups in the molecule, and the like. Examples of commercially available products include “TETRAD C”®, produced by Mitsubishi Gas Chemical Company Inc.

The amount of the crosslinking agent used is not particularly limited and, for example in the case of an acrylic pressure-sensitive adhesive layer, it is preferably 0 to 5 parts by weight, and more preferably 0 to 3 parts by weight with respect to the total amount of the acrylic polymer-forming monomer components (100 parts by weight).

The method of forming the pressure-sensitive adhesive layer in the pressure-sensitive adhesive tape according to the present invention, may be any known common method of forming the pressure-sensitive adhesive layer and varies, for example, according to the polymerization method of the base polymer. An example of the method is one of the following methods (1) to (3), although it is not particularly limited thereto. (1) A pressure-sensitive adhesive layer is formed by coating (applying) a composition containing a mixture of monomer components (monomer mixture) for preparation of the base polymer (such as the acrylic polymer) or the partial polymer thereof, and as needed, additives such as photopolymerization initiators and crosslinking agents on a base or separator and irradiating the coated layer formed thereon with active energy ray (particularly preferably ultraviolet ray). (2) A pressure-sensitive adhesive layer is formed by coating (applying) a composition (solution) containing the base polymer, a solvent, and additives such as crosslinking agents as needed on a base or separator, and drying and/or hardening the coated layer. (3) The pressure-sensitive adhesive layer formed in (1) is dried further. Among the methods above, the method of forming the pressure-sensitive adhesive layer (1) or (3) is preferable because it is possible to produce a thicker pressure-sensitive adhesive layer and improve the cleavage adhesive strength and shear adhesive strengths of the pressure-sensitive adhesive tape effectively. Thus, the pressure-sensitive adhesive layer in the pressure-sensitive adhesive tape according to the present invention is preferably a pressure-sensitive adhesive layer formed by irradiating a pressure-sensitive adhesive composition, containing a monomer mixture or the partial polymer thereof, and additives such as photopolymerization initiators and crosslinking agents as needed with active energy ray (in particular, ultraviolet ray).

Any known coating methods can be used in coating (application) for preparation of the pressure-sensitive adhesive layer, and common coaters, such as gravure roll coater, reverse roll coater, kiss roll coater, dip roll coater, bar coater, knife coater, spray coater, comma coater, and direct coater can be used.

When the pressure-sensitive adhesive tape according to the present invention is a single-sided pressure-sensitive adhesive tape, the thickness of the pressure-sensitive adhesive layer is preferably 20 to 400 μm, more preferably 30 to 350 μm, and particularly preferably 40 to 300 μm. When the thickness of the pressure-sensitive adhesive layer is less than 20 μm, it is not possible to control the cleavage adhesive strength and the shear adhesive strength of the pressure-sensitive adhesive tape in the particular ranges above, possibly resulting in dislocation or separation of the honeycomb core during cutting operation. On the other hand, a thickness of more than 400 μm may lead to deterioration of the workability of the pressure-sensitive adhesive tape.

When the pressure-sensitive adhesive tape according to the present invention is a double-side pressure-sensitive adhesive tape, the thickness of the honeycomb core-side pressure-sensitive adhesive layer is preferably 20 to 400 μm, more preferably 30 to 350 μm, and particularly preferably 40 to 300 μm. When the thickness of the honeycomb core-side pressure-sensitive adhesive layer is less than 20 μm, it is not possible to control the cleavage adhesive strength and the shear adhesive strength of the pressure-sensitive adhesive tape in the particular ranges described above, possibly resulting in dislocation or separation of the honeycomb core during cutting operation. A thickness of the honeycomb core-side pressure-sensitive adhesive layer of more than 400 μm may lead to fracture of the honeycomb core during its separation and consequently deterioration in cutting operability. The thickness of the operating machine-side pressure-sensitive adhesive layer is preferably 20 to 400 μm, and more preferably 40 to 300 μm, although it is not particularly limited thereto.

The gel fraction of the pressure-sensitive adhesive layer in the pressure-sensitive adhesive tape according to the present invention is preferably 60 to 99%, more preferably 65 to 95%, and particularly preferably 70 to 95%. The gel fraction can be determined as ethyl acetate-insoluble matter, specifically as the weight fraction of the sample (insoluble) after immersion in ethyl acetate at 23° C. for 7 days compared to the sample before immersion (unit: wt %). A gel fraction of less than 60% may lead to deterioration of the shear adhesive strength of the pressure-sensitive adhesive tape. Meanwhile, a gel fraction of more than 99% may lead to deterioration of the cleavage adhesive strength of the pressure-sensitive adhesive tape. When the pressure-sensitive adhesive tape according to the present invention is a double-sided pressure-sensitive adhesive tape, at least the gel fraction of the honeycomb core-sided pressure-sensitive adhesive layer should satisfy the range above. The gel fraction (rate of solvent-insoluble matter) is specifically a value calculated, for example, by the following “gel fraction-determining method”.

### (Gel Fraction-Determining Method)

Approximately 0.1 g of the pressure-sensitive adhesive layer in the pressure-sensitive adhesive tape according to the present invention is sampled, covered by a porous tetrafluoroethylene sheet (trade name: “NTF1122”, produced by Nitto Denko Corporation) having an average pore size of 0.2 μm and tied with a kite string, and the weight of the tied sample is determined as the weight before immersion. The weight before immersion is the total weight of the pressure-sensitive adhesive layer (the pressure-sensitive adhesive layer obtained above), the tetrafluoroethylene sheet and the kite string. The total weight of the tetrafluoroethylene sheet and the kite string is also determined as the wrapper weight.

The pressure-sensitive adhesive layer wrapped with the tetrafluoroethylene sheet and tied with the kite string (hereinafter, referred to as “sample”) is then placed in a 50-ml container filled with ethyl acetate and left still therein at 23° C. for 7 days. The sample (after ethyl acetate treatment) is then withdrawn from the container, transferred into an aluminum cup, and dried at 130° C. for 2 hours in a drier for removal of ethyl acetate. Then the weight thereof is determined as the weight after immersion.

Gel fraction (wt %)=(A−B)/(C−B)×100 (1)

(in Formula (1), “A” represents the weight after immersion; “B” represents the wrapper weight; and “C” represents the weight before immersion.)

The gel fraction can be controlled, for example, by adjustment of the amount of the crosslinking agent and the intensity of the active energy ray irradiated.

The storage elastic modulus at 23° C., as determined by dynamic viscoelasticity measurement, of the pressure-sensitive adhesive layer in the pressure-sensitive adhesive tape according to the present invention (hereinafter, referred to as “storage elastic modulus (23° C.)” or “G′ (23° C.)”) is preferably 1.0×10⁵ to 3.0×10⁵ Pa, more preferably 1.2×10⁵ to 2.5×10⁶ Pa. A storage elastic modulus (23° C.) of more than 3.0×10⁵ Pa may lead to deterioration of the cleavage adhesive strength of the pressure-sensitive adhesive tape. Alternatively, a storage elastic modulus (23° C.) of less than 1.0×10⁵ Pa may lead to deterioration of the shear adhesive strength of the pressure-sensitive adhesive tape. When the pressure-sensitive adhesive tape according to the present invention is a double-sided pressure-sensitive adhesive tape, at least the storage elastic modulus (23° C.) of the honeycomb core-side pressure-sensitive adhesive layer should satisfy the range above. The storage elastic modulus is determined by dynamic viscoelasticity measurement. It can be determined, for example, by laminating multiple pieces of the pressure-sensitive adhesive layers to a thickness of approximately 1.5 mm, and analyzing the sample in the temperature range of −70 to 200° C. at a heating rate of 5° C./minute in “Advanced Reometric Expansion System (ARES)” manufactured by Reometric Scientific under the condition of a frequency of 1 Hz in the shear mode.

The storage elastic modulus (23° C.) can be controlled, for example, by adjustment of the amount of the crosslinking agent, the intensity of the active energy ray irradiated, or the composition of the pressure-sensitive adhesive layer.

### [Base]

The base in the pressure-sensitive adhesive tape according to the present invention is not particularly limited, and examples thereof include suitable sheet-shaped products, specifically paper bases such as paper; fiber bases such as woven and nonwoven fabrics and nets; metal bases such as metal foils and metal plates; plastic bases (plastic films) such as films and sheets of various resins (olefinic resins, polyester resins (such as PET films), polyvinyl chloride resins, vinyl acetate resins, amide resins, polyimide resins, polyether ether ketone (PEEK) resins, and polyphenylene sulfide (PPS) resins); rubber bases such as rubber sheets; foams such as foam sheets; laminated films of these bases (in particular, laminated films of a plastic base and another base, laminated films of plastic films (or sheets); and the like. Use of a plastic base (plastic film) among them is preferable and use of a PET film is more preferable, from the viewpoint of the breaking strength of the pressure-sensitive adhesive tape.

The thickness of the base is not particularly limited and, for example, preferably 2 to 200 μm, more preferably 2 to 100 μm, and still more preferably 12 to 75 μm. A base thickness of less than 2 μm may lead to insufficient breaking strength of the pressure-sensitive adhesive tape. Meanwhile, a base thickness of more than 200 μm may lead to excessive increase of the rigidity of the pressure-sensitive adhesive tape, resulting in deterioration in fittability to the honeycomb core. The base may have a single- or multi-layer shape. The base may be subjected, as needed, to various treatments such as rear-face treatment, anti-electrostatic treatment, and undercoat treatment.

The breaking strength in the machine direction (MD) and the breaking strength in the transverse direction (TD) of the base are both preferably 30 to 200 N/10 mm, and more preferably 30 to 100 N/10 mm. When at least one of the breaking strength in the machine direction (MD) and that in the transverse direction (TD) is less than 30 N/10 mm, the pressure-sensitive adhesive tape is broken easily when the pressure-sensitive adhesive tape is peeled off after cutting operation, occasionally leading to deterioration in cutting operability. A breaking strength of more than 200 N/10 mm may lead to excessive increase in rigidity of the pressure-sensitive adhesive tape and accompanied deterioration in fittability thereof to the honeycomb core.

The pressure-sensitive adhesive tape according to the present invention may have other layers (such as intermediate layer and undercoat layer), in the range that does not impair the advantageous effects of the invention.

A separator (release liner) may be laid on the surface (adhesive face) of the pressure-sensitive adhesive layer in the pressure-sensitive adhesive tape according to the present invention, until the adhesive tape is used. The separator, which is used as a protective material for the pressure-sensitive adhesive layer, is removed before the adhesive tape is bonded to the bonding target. The separator may not be laid on the surface of the pressure-sensitive adhesive tape. When the pressure-sensitive adhesive tape according to the present invention is a double-sided pressure-sensitive adhesive tape, for example, it may be a so-called double separator-type pressure-sensitive adhesive tape in the configuration having separators respectively laid on both adhesive faces, or a single separator type pressure-sensitive adhesive tape which is winded to protect both adhesive faces by a single separator.

The separator is not particularly limited and may be, for example, a commonly used release paper, and examples thereof include bases having a release coating layer, weakly adhesive bases of fluorine-containing polymer, weakly adhesive bases of non-polar polymer, and the like. The bases having a release coating layer are, for example, plastic films and papers surface-treated with a release coating agent such as a silicone-, long-chain alkyl- or fluorine-based agent or molybdenum sulfide. Examples of the fluorine-containing polymers include polytetrafluoroethylene, polychlorotrifluoroethylene, polyvinyl fluoride, polyvinylidene fluoride, tetrafluoroethylene-hexafluoropropylene copolymers, chlorofluoroethylene-vinylidene fluoride copolymers, and the like. Examples of the non-polar polymers include olefinic resins (such as polyethylene and polypropylene) and the like. The separator can be prepared by a known commonly used method. The thickness and others of the separator are also not particularly limited.

The pressure-sensitive adhesive tape according to the present invention can be produced by a known commonly used method of producing a pressure-sensitive adhesive tape. For example, the pressure-sensitive adhesive layer described above may be formed directly on the surface of a base (direct application method) or alternatively, the pressure-sensitive adhesive layer may be formed on the base, as the pressure-sensitive adhesive layer described above is once formed on the separator and then transferred (laminated) onto the base (transfer method).

The total thickness of the pressure-sensitive adhesive tape according to the present invention is preferably 50 to 1000 μm, more preferably 60 to 900 μm, and still more preferably 70 to 800 μm. When the total thickness of the pressure-sensitive adhesive tape according to the present invention is less than 50 μm, it may not be possible to obtain sufficient adhesive strength during cutting of the honeycomb core, and a total thickness of more than 1000 μm may lead to fracture of the honeycomb core when it is separated. The “total thickness” does not include the thickness of the separator (release liner) laid on the pressure-sensitive adhesive layer surface.

### [Physical Properties of Pressure-Sensitive Adhesive Tape]

The cleavage adhesive strength of the pressure-sensitive adhesive tape according to the present invention is 10 to 80 N/400 mm², preferably 10 to 70 N/400 mm², and more preferably 15 to 60 N/400 mm². A cleavage adhesive strength of less than 10 N/400 mm² leads to dislocation or separation of the honeycomb core during cutting operation of the honeycomb core and also to deterioration in cutting operability. When the cleavage adhesive strength is more than 80 N/400 mm², large force is needed for separation of the pressure-sensitive adhesive tape after cutting operation of the honeycomb core, which leads to breakage of the pressure-sensitive adhesive tape, fracture of the honeycomb core and adhesive deposit and thus to deterioration in cutting operability.

The cleavage adhesive strength represents the resistance against separation of the adherend at the adhesion interface when a force is applied in the direction perpendicular to the adhesive face between the pressure-sensitive adhesive tape and the adherend. Thus, when the cleavage adhesive strength is larger, the honeycomb core is less likely dislocated (vertically) and separated less easily from the table of the operating machine during cutting operation of the honeycomb core.

Specifically, the cleavage adhesive strength can be determined, for example, by the following test (cleavage adhesive strength test). When the pressure-sensitive adhesive tape according to the present invention is a double-sided pressure-sensitive adhesive tape, the adhesive face (surface of the pressure-sensitive adhesive layer) of a pressure-sensitive adhesive tape (size: 20 mm×20 mm, area: 400 mm²) is bonded to the end of a SUS plate (a) (size: width 30 mm×length 80 mm, thickness 2.0 mm) in the longitudinal direction and the other adhesive face to a table-sided SUS plate (b) (size: width 50 mm×length 125 mm, thickness 2.0 mm). The composite is, as needed, pressurized and aged to give a test sample. When the pressure-sensitive adhesive tape according to the present invention is a single-sided pressure-sensitive adhesive tape, the base face (base surface) of the pressure-sensitive adhesive tape (size: 20 mm×20 mm, area: 400 mm²) is bonded to a SUS plate (b) with an adhesive and the adhesive face is additionally bonded to the end of a SUS (a) in the longitudinal direction, and the composite is, as needed, pressurized and aged to give a test sample. The SUS plate (b) is fixed, and the end in the region of the SUS plate (a) opposite to the region bonded to the pressure-sensitive adhesive tape in the longitudinal direction is pulled in the direction perpendicular to the surface of the SUS plate (b) at a velocity of 300 mm/minute under an atmosphere of 23° C. and 50% RH, for determination of the load needed for separation of the pressure-sensitive adhesive tape, as the cleavage adhesive strength (N/400 mm²). More specifically, it can be determined by the test method described below in (Evaluation), “(7) Cleavage adhesive strength”. When the pressure-sensitive adhesive tape according to the present invention is a double-sided pressure-sensitive adhesive tape, the cleavage adhesive strength preferably satisfies the range above, even when any adhesive face is bonded to the SUS plate (a).

The cleavage adhesive strength can be controlled by adjustment of the composition of the pressure-sensitive adhesive layer, the amount of the crosslinking agent, the intensity of the active energy ray irradiated, or the like.

The shear adhesive strength of the pressure-sensitive adhesive tape according to the present invention is 100 to 700 N/400 mm², preferably 120 to 680 N/400 mm², and more preferably 150 to 650 N/400 mm². When the shear adhesive strength is less than 100 N/400 mm², the honeycomb core is dislocated or separated during cutting operation of the honeycomb core and the cutting operability is declined. Alternatively, a shear adhesive strength of more than 700 N/400 mm² causes troubles such as fracture when the honeycomb core is separated.

The shear adhesive strength represents the resistance against dislocation of the adherend generated at the adhesion interface when a force is applied in the direction parallel to the adhesive face between the pressure-sensitive adhesive tape and the adhered. Thus, when the shear adhesive strength is larger, the honeycomb core is less likely to be dislocated (laterally) during cutting operation of the honeycomb core and the honeycomb core is dislocated less easily in the operating machine.

The shear adhesive strength can be determined in the following way: Two test plates (SUS304 plate) are bonded to each other via the pressure-sensitive adhesive tape according to the present invention (size: 20 mm×20 mm, area: 400 mm²) and the composite is, as needed, pressurized and aged to give a test sample. Then in a state that one end of the test plate is fixed, the other end is pulled in the direction parallel to the test plate surface (tensile speed: 50 mm/minute) under the condition of 23° C. and 50% RH by using a tensile tester, for determination of the load when the pressure-sensitive adhesive tape is separated as shear adhesive strength (N/400 mm²). When the pressure-sensitive adhesive tape according to the present invention is a single-sided pressure-sensitive adhesive tape, the measurement can be carried out, by bonding the base face to one test plate with an adhesive. More specifically, it can be determined by the test method described below (Evaluation), “(6) Shear adhesive strength”.

The shear adhesive strength can be controlled by adjustment of the composition of the pressure-sensitive adhesive layer, the amount of the crosslinking agent, the intensity of the active energy ray irradiated, or the like.

The breaking strength in the machine direction (MD) and the breaking strength in the transverse direction (TD) of the pressure-sensitive adhesive tape according to the present invention are both 30 to 200 N/10 mm, preferably 35 to 180 N/10 mm, and more preferably 40 to 150 N/10 mm. When at least one of the breaking strength in the machine direction (MD) and the breaking strength in the transverse direction (TD) is less than 30 N/10 mm, the pressure-sensitive adhesive tape is broken easily during separation of the pressure-sensitive adhesive tape after cutting operation, leading to deterioration in cutting operability. Alternatively, the breaking strength of more than 200 N/10 mm leads to excessive increase in rigidity of the pressure-sensitive adhesive tape, and deterioration in fittability to the honeycomb core and in cutting operability.

The breaking strength is determined according to JIS Z0237. Specifically, the breaking strength (N/10 mm) can be determined by measuring the load at break of the pressure-sensitive adhesive tape (tensile strength) when the pressure-sensitive adhesive tape according to the present invention (dumbbell-shaped No. 2 test piece) with a marked line distance of 10 mm is pulled at a velocity of 100 mm/minute under an atmosphere of 23° C. and 50% RH, by using a tensile tester. More specifically, it can be determined, for example, by the test method described below (Evaluation), “(5) Breaking strength”.

The breaking strength can be controlled, for example, by adjustment of the kind of the base and the thickness of the base.

The 180° peel adhesive power to SUS plate of the pressure-sensitive adhesive tape according to the present invention (hereinafter, referred to as “180° peel adhesive power (to SUS)”) is preferably 3 to 30 N/20 mm, more preferably 5 to 25 N/20 mm. When the 180° peel adhesive power (to SUS) is less than 3 N/20 mm, there may be dislocation or separation of the honeycomb core during cutting operation. The 180° peel adhesive power (to SUS) of more than 30 N/20 mm may lead to breakage of the pressure-sensitive adhesive tape during separation of the pressure-sensitive adhesive tape after cutting operation, fracture of the honeycomb core, or adhesive deposit. When the pressure-sensitive adhesive tape according to the present invention is a double-sided pressure-sensitive adhesive tape, the 180° peel adhesive power (to SUS) of both adhesive faces preferably satisfy the range above. The 180° peel adhesive power (to SUS) in the present invention can be determined according to the 180° peel test of JIS Z-0237. Specifically, for example, the pressure-sensitive adhesive tape according to the present invention is bonded to SUS plate as an adherend (test plate), and the composite is pressurized and aged to give a test sample. The load during separation can be determined, as the 180° peel adhesive power (to SUS), as the pressure-sensitive adhesive tape is peeled off to an angle of 180° under the condition of a tensile speed of 300 mm/minute and under an atmosphere of 23° C. and 50% RH by using a tensile tester. When the pressure-sensitive adhesive tape according to the present invention is a double-sided pressure-sensitive adhesive tape, the measurement can be made by bonding a backing material (for example, a PET film having a thickness of 25 μm) onto the surface of the pressure-sensitive adhesive layer (adhesive face) opposite to the measuring face.

The 180° peel adhesive power to the honeycomb core of the pressure-sensitive adhesive tape according to the present invention (hereinafter, referred to as “180° peel adhesive power (to honeycomb core)”) is preferably 0.5 to 10 N/25 mm, more preferably 0.7 to 8.0 N/25 mm. When the 180° peel adhesive power (to honeycomb core) is less than 0.5 N/25 mm, there may be dislocation or separation of the honeycomb core during cutting operation. On the other hand, a 180° peel adhesive power of more than 10 N/25 mm may lead to fracture of the honeycomb core or adhesive deposit, when the pressure-sensitive adhesive tape is peeled off after cutting operation. When the pressure-sensitive adhesive tape according to the present invention is a double-sided pressure-sensitive adhesive tape, the 180° peel adhesive power (to honeycomb core) on both adhesive faces preferably satisfy the range above. The 180° peel adhesive power (to honeycomb core) can be determined according to the 180° peel test of JIS Z0237, and can be determined in a manner similar to the 180° peel adhesive power (to SUS) described above, except that a honeycomb core (such as Nomex honeycomb) is used as the adherend. The Nomex honeycomb is a honeycomb core prepared from the fiber of an aramide (wholly aromatic polyamide) polymer.

The 180° peel adhesive power (to SUS) and the 180° peel adhesive power (to honeycomb core) can be controlled by adjustment of, for example, the composition of the pressure-sensitive adhesive layer, the thickness of the pressure-sensitive adhesive layer, or the amount of the crosslinking agent.

The pressure-sensitive adhesive tape according to the present invention is preferably superior in holding power (holding efficiency). The holding power can be evaluated by the holding power test according to JIS Z 0237. Specifically, it is evaluated, for example, by pressing the pressure-sensitive adhesive tape according to the present invention onto a Bakelite plate {pressurized area: 200 mm² (size: 10 mm×20 mm)}, as it is fixed on the Bakelite plate, applying a tensile load of 9.8 N on the pressure-sensitive adhesive tape for 1 hour under an atmosphere of 40° C. and 50% RH, and then measuring the distance dislocated from the original bonding position (displacement distance). In the case of a double-sided pressure-sensitive adhesive tape, measurement is possible, if a backing material (for example, a PET film having a thickness of 25 μm) is bonded to the surface (adhesive face) of the pressure-sensitive adhesive layer opposite to the measuring face. The displacement distance in the holding power test is preferably 5.0 mm or less, and more preferably 3.0 mm or less. A displacement distance of more than 5.0 mm may lead to dislocation or separation of the honeycomb core during cutting operation. The lowest value of the displacement distance is not particularly limited, but preferably 0.0 mm.

The holding power can be controlled by adjustment of, for example, the composition of the pressure-sensitive adhesive layer, the thickness of the pressure-sensitive adhesive layer, or the amount of the crosslinking agent.

In the pressure-sensitive adhesive tape according to the present invention, the release force of the separator (release liner) laid on the surface of the pressure-sensitive adhesive layer with respect to the pressure-sensitive adhesive layer (hereinafter, referred to as “release force of separator”) is preferably 0.1 to 5.0 N/50 mm, and more preferably 0.1 to 4.0 N/50 mm. The release force of less than 0.1 N/50 mm may lead to deterioration in protective performance. The release force of more than 5.0 N/50 mm may lead to decrease in release property. When the pressure-sensitive adhesive tape according to the present invention is a double separator-type double-sided pressure-sensitive adhesive tape, the release force of any one of the two separators preferably satisfies the range above. The release force of the separator can be determined according to the 180° peel test of separator specified in JIS Z0237. Specifically, the release force of the separator can be determined, for example, by measuring the load when the separator is peeled off to an angle of 180° from the pressure-sensitive adhesive tape according to the present invention under an atmosphere of 23° C. and 50% RH and under the condition of a tensile speed of 300 mm/minute. When the pressure-sensitive adhesive tape according to the present invention is a double-sided pressure-sensitive adhesive tape, the measurement can be made as a backing material (for example, a PET film having a thickness of 25 μm) is bonded to the surface (adhesive face) of the pressure-sensitive adhesive layer opposite to the measuring face.

The pressure-sensitive adhesive tape according to the present invention is used, during cutting operation of the honeycomb core, as a pressure-sensitive adhesive tape for fixing the honeycomb core onto the table of the operating machine (a pressure-sensitive adhesive tape for fixing a honeycomb core during cutting operation). When the pressure-sensitive adhesive tape according to the present invention is used as a pressure-sensitive adhesive tape for fixing a honeycomb core during cutting operation, the honeycomb core can be fixed on the table of the operating machine without dislocation or separation of the honeycomb core during cutting operation. It is also possible, after cutting operation, to peel off the pressure-sensitive adhesive tape without fracture of the honeycomb core or adhesive deposit. Thus, the pressure-sensitive adhesive tape according to the present invention, improves the cutting operability and the productivity of the worked honeycomb core.

The method of fixing the honeycomb core onto the operating machine by using the pressure-sensitive adhesive tape is not particularly limited. In a preferred embodiment, when the pressure-sensitive adhesive tape according to the present invention is a double-sided pressure-sensitive adhesive tape, the honeycomb core is fixed onto the table of the operating machine, as a honeycomb core is bonded to one adhesive face (honeycomb core-side pressure-sensitive adhesive layer surface) and an air-tight sheet material (for example, PET film) to the other adhesive face (operating machine-side pressure-sensitive adhesive layer surface), and then the sheet material is adsorbed on the table of the operating machine under vacuum. In another preferred embodiment, when the pressure-sensitive adhesive tape is a single-sided pressure-sensitive adhesive tape, the honeycomb core is fixed onto the table of the operating machine, as a honeycomb core is bonded to the adhesive face of the pressure-sensitive adhesive tape and the base-sided face (opposite to the adhesive face) of the pressure-sensitive adhesive tape is adsorbed on the table of the operating machine under vacuum.

The pressure-sensitive adhesive tape according to the present invention can be used for honeycomb cores in any structure, for example in hexagonal honeycomb structure, over-expanded honeycomb structure, Flex-Core honeycomb structure, square honeycomb structure, or under-expanded honeycomb structure, and the cell size, the cell pitch, and others of the honeycomb core are not limited either. The material for the honeycomb core fixed with the pressure-sensitive adhesive tape according to the present invention is not particularly limited and may be, for example, paper, fiber or the resin-impregnated product thereof, rubber, synthetic resin, metal (such as aluminum, stainless steel, lead or titanium). Among them, aluminum or aramide honeycomb cores are used preferably. The shape before cutting operation, the shape after cutting, the thickness and others of the honeycomb core are not particularly limited either.

### EXAMPLES

Hereinafter, the present invention will be described more in detail with reference to Examples, but it should be understood that the present invention is not restricted by these Examples. When the thicknesses of the pressure-sensitive adhesive layers formed on both sides of the base in a double-sided pressure-sensitive adhesive tape are different from each other, the thicker pressure-sensitive adhesive layer is generally used as the “honeycomb core-side pressure-sensitive adhesive layer” described above. When the thicknesses of the pressure-sensitive adhesive layers formed on both sides of the base are the same as each other, either one of the pressure-sensitive adhesive layers may be used as the “honeycomb core-side pressure-sensitive adhesive layer”.

### Example 1

### Preparation of Partial Polymer (UV Sirup) (A)

0.05 parts by weight of a photopolymerization initiator, “IRGACURE 651”® (product of Ciba Specialty Chemicals) and 0.05 parts by weight of “IRGACURE 184”® (product of Ciba Specialty Chemicals) were blended with a mixture of 90 parts by weight of isononyl acrylate and 10 parts by weight of acrylic acid, and the mixture was irradiated with ultraviolet ray to a viscosity of 20 Pa·s to give a partial polymer (A), in which some of the monomer components are polymerized.

### Preparation of Acrylic Pressure-Sensitive Adhesive Composition (B)

0.2 parts by weight of trimethylolpropane triacrylate, 0.2 parts by weight of isononyl acrylate and 1.0 parts by weight of an antioxidant “Irganox 1010”® (product of Ciba, Japan) were added to 100 parts by weight of the partial polymer (A) thus obtained, and the mixture was blended uniformly, to give an acrylic pressure-sensitive adhesive composition (B).

### Preparation of First Laminate Product (C)

The acrylic pressure-sensitive adhesive composition (B) was coated on a silicone-treated paper having a thickness of 125 μm to make a thickness of a pressure-sensitive adhesive layer 50 μm after drying, to form a coated layer. A polyethylene terephthalate (PET) film silicone-treated on one side (release film) (thickness: 38 μm) was then laid on the coated layer, with silicone-treated face (release coating face) facing the coated layer, covering the coated layer to block oxygen. The laminated film of “silicone-treated paper/coated layer/release film” was irradiated from the top face (release film side) with ultraviolet light from a metal halide lamp at an illuminance of 280 mW/cm² (measured by UV Checker “UVR-T1”, manufactured by TOPCON Corp.) for approximately 2 minutes. After removal of the release film, the laminate was heat-treated in a drier at 120° C. for 1 minute for evaporation of the residual monomers, and a PET film base having a thickness of 38 μm (PET base) was bonded to the coated layer after drying (pressure-sensitive adhesive layer), to give a first laminate product (C) (laminated film of “silicone-treated paper/pressure-sensitive adhesive layer/PET base”).

### Preparation of Acrylic Double-Sided Pressure-Sensitive Adhesive Tape

### Second Laminate Product

The acrylic pressure-sensitive adhesive composition (B) was coated on the top face (PET base side) of the first laminate product (C) to make a thickness of a pressure-sensitive adhesive layer 125 μm after drying, and the composite was irradiated with ultraviolet ray and dried in a similar manner to above to give a PET film base-attached acrylic double-sided pressure-sensitive adhesive tape in a configuration of “silicone-treated paper/pressure-sensitive adhesive layer/PET base/pressure-sensitive adhesive layer”.

### Example 2

A PET film base-attached acrylic double-sided pressure-sensitive adhesive tape was prepared in a manner completely identical to Example 1, except that coating was made to make a thickness of the pressure-sensitive adhesive layer after drying 125 μm in the first coating and 50 μm in the second coating.

### Example 3

### Preparation of Acrylic Single-Sided Pressure-Sensitive Adhesive Tape

The acrylic pressure-sensitive adhesive composition (B) was coated on a PET film base (PET base) having a thickness of 38 μm to make a thickness of a pressure-sensitive adhesive layer 250 μm after drying to form a coated layer. A PET film silicone-treated on one side (release film) (thickness: 38 μm) was then laid on the coated layer with its silicone-treated face (release coating face) facing the coated layer, covering the coated layer to block oxygen. The laminated film of “PET base/coat film/release film” was irradiated from both sides with ultraviolet light using a black light lamp at an illuminance of 4 mW/cm² (measured by UV Checker “UVR-T1”, manufactured by TOPCON Corp.) for 3 minutes. After removal of the release film, a silicone-treated paper (separator) having a thickness of 125 μm was bonded thereto, to give a PET film base-attached acrylic single-sided pressure-sensitive adhesive tape in the configuration of “PET base/pressure-sensitive adhesive layer/silicone-treated paper”.

### Example 4

A PET film base-attached acrylic single-sided pressure-sensitive adhesive tape was prepared in a manner completely identical to Example 3, except that coating was made to make a thickness of the pressure-sensitive adhesive layer after drying 125 μm.

### Example 5

A PET film base-attached acrylic double-sided pressure-sensitive adhesive tape was prepared in a manner completely identical to Example 1, except that coating was made to make a thickness of the pressure-sensitive adhesive layer after drying 250 μm in the first coating and at 250 μm in the second coating.

### Example 6

A PET film base-attached acrylic double-sided pressure-sensitive adhesive tape was prepared in a manner completely identical to Example 1, except that coating was made to make a thickness of the pressure-sensitive adhesive layer after drying 300 μm in the first coating and 300 μm in the second coating.

### Example 7

A PET film base-attached acrylic double-sided pressure-sensitive adhesive tape was prepared in a manner completely identical to Example 5, except that the thickness of the PET film base (PET base) was changed to 25 μm.

### Comparative Example 1

### Preparation of Acrylic Pressure-Sensitive Adhesive Composition (D)

0.08 parts by weight of a polymerization initiator 2,2′-azobisisobutylonitrile (AIBN) was added to a monomer mixture containing 70 parts by weight of butyl acrylate (n-butyl acrylate), 30 parts by weight of 2-ethylhexyl acrylate, 3 parts by weight of acrylic acid and 0.05 parts by weight of 4-hydroxybutyl acrylate, and the mixture was allowed to polymerize in toluene solution, to give an acrylic polymer-containing solution. A tackifier “Pencel D-125”® (manufactured by Arakawa Chemical Industries, Ltd.) in an amount of 30 parts by weight and a crosslinking agent “CORONATE L”® (manufactured by Nippon Polyurethane Industry Co., Ltd.) in an amount of 2 parts by weight with respect to 100 parts by weight of the acrylic polymer were added to the solution, and the mixture was agitated thoroughly to give an acrylic pressure-sensitive adhesive composition (D).

### Preparation of Acrylic Double-Sided Pressure-Sensitive Adhesive Tape

The acrylic pressure-sensitive adhesive composition (D) was coated on a PET separator (PET film silicone-treated on its surface) to make a thickness of a pressure-sensitive adhesive layer 4 μm after drying and dried at a temperature of 120° C. for 2 minutes. The laminated film of “PET separator/pressure-sensitive adhesive layer” thus prepared was bonded to both faces of a PET film base (PET base) having a thickness of 2 μm to give a PET base-attached acrylic double-sided pressure-sensitive adhesive tape.

### Comparative Example 2

### Preparation of Acrylic Pressure-Sensitive Adhesive Composition (E)

0.2 parts by weight of a polymerization initiator 2,2′-azobisisobutylonitrile (AIBN) was added to a monomer mixture containing 100 parts by weight of butyl acrylate (n-butyl acrylate), 5 parts by weight of vinyl acetate, 3 parts by weight of acrylic acid, and 0.1 parts by weight of hydroxyethyl acrylate (2-hydroxyethyl acrylate), and the mixture was allowed to polymerize in toluene/ethyl acetate solution, to give an acrylic polymer-containing solution.

“Rikatac SE10”® (produced by Rika Fine Tech Co., Ltd.) in an amount of 10 parts by weight, “Rikatac PCJ”® (produced by Rika Fine Tech Co., Ltd.) in an amount of 10 parts by weight, “Hercolyn D”® (produced by Hercules) in an amount of 5 parts by weight, “SUMILITE”® (produced by Sumitomo Bakelite) in an amount of 15 parts by weight, and a crosslinking agent “CORONATE L”® (produced by Nippon Polyurethane Industry Co., Ltd.) in an amount of 2 parts by weight with respect to 100 parts by weight of the acrylic polymer were added to the solution, and the mixture was agitated thoroughly to give an acrylic pressure-sensitive adhesive composition (E).

### Preparation of Acrylic Double-Sided Pressure-Sensitive Adhesive Tape

The acrylic pressure-sensitive adhesive composition (E) was coated on a silicone-treated paper to make a thickness of a pressure-sensitive adhesive layer 42 μm after drying and dried at a temperature of 120° C. for 2 minutes. The laminated film of “silicone-treated paper/pressure-sensitive adhesive layer” thus prepared was bonded to both faces of a nonwoven fabric (nonwoven fabric base) having a thickness of 76 μm (basis weight: 23 g/m²) to give a nonwoven fabric base-attached acrylic double-sided pressure-sensitive adhesive tape.

### Comparative Example 3

### Preparation of Acrylic Pressure-Sensitive Adhesive Composition (F)

0.21 parts by weight of a polymerization initiator 2,2′-azobisisobutylonitrile (AIBN) is added to a monomer mixture containing 100 parts by weight of butyl acrylate (n-butyl acrylate) and 3 parts by weight of acrylic acid, and the mixture was allowed to polymerize in toluene solution, to give an acrylic polymer-containing solution.

“SUMILITE”® (produced by Sumitomo Bakelite) in an amount of 20 parts by weight, “Nikanol H-80”® (produced by Mitsubishi Gas Chemical Company) in an amount of 30 parts by weight, “EDP-300”® (produced by ADEKA Corp.) in an amount of 0.035 parts by weight, a crosslinking agent “CORONATE L”® (produced by Nippon Polyurethane Industry Co., Ltd.) in an amount of 2.64 parts by weight with respect to 100 parts by weight of the acrylic polymer were added to the solution, and the mixture was agitated thoroughly, to give an acrylic pressure-sensitive adhesive composition (F).

### Preparation of Acrylic Double-Sided Pressure-Sensitive Adhesive Tape

The acrylic pressure-sensitive adhesive composition (F) was coated on a silicone-treated paper (silicone release liner) to make a thickness of a pressure-sensitive adhesive layer 66 μm after drying and dried at a temperature of 120° C. for 2 minutes. The laminated film of “silicone release liner/pressure-sensitive adhesive layer” thus prepared was bonded to both faces of a nonwoven fabric (nonwoven fabric base) having a thickness of 38 μm (basis weight: 14.0 g/m²) to give a nonwoven fabric base-attached acrylic double-sided pressure-sensitive adhesive tape.

### (Evaluation)

The Pressure-Sensitive Adhesive Sheets Obtained in the Examples and Comparative Examples above were evaluated in the following tests. Evaluation results are summarized in Table 1. In the case of double-sided pressure-sensitive adhesive sheets in Examples, the side of the pressure-sensitive adhesive layer prepared by the second coating was used as the first face side and the side of the pressure-sensitive adhesive layer prepared by the first coating was used as the second face side. In the case of the pressure-sensitive double-faced adhesive sheets in Comparative Examples, the pressure-sensitive adhesive layers are not different from each other because of the production process, and thus, any adhesive face may be used as the first or second face side.

### (1) 180° Peel Adhesive Power (to SUS)

A strip-shaped tape sample (size: width 20 mm×length 100 mm) was cut off from each of the pressure-sensitive adhesive tapes obtained in Examples and Comparative Examples. In the case of a double-sided pressure-sensitive adhesive tape, a PET film having a thickness of 25 μm (“LUMIRROR S-10”, produced by Toray Industries, Inc.) was bonded (for backing) to the adhesive face opposite to the measuring face.

The measuring face of the strip-shaped tape sample was then bonded to a SUS plate (SUS304) (width 50 mm×length 125 mm, thickness 2.0 mm), and the tape sample was bonded under pressure by single reciprocation with a 2-kg roller. It is then aged under an atmosphere of 23° C. and 50% RH for 0.5 hour, to give a test sample.

The 180° peel test of the pressure-sensitive adhesive tape (strip-shaped tape sample) was performed by using the test sample, and the 180° peel adhesive power (to SUS) of the pressure-sensitive adhesive tape to the SUS plate (N/20 mm) was determined. Measurement was made in an atmosphere of 23° C. and 50% RH under the condition of a peel angle of 180° and a tensile speed of 300 mm/minute by using a tensile tester. In the case of a double-sided pressure-sensitive adhesive tape, the 180° peel adhesive power (to SUS) of both adhesive faces was determined.

### (2) 180° Peel Adhesive Power (to Honeycomb Core)

A strip-shaped tape sample (size: width 25 mm×length 100 mm) was cut off from each of the pressure-sensitive adhesive tapes obtained in Examples and Comparative Examples. In the case of a double-sided pressure-sensitive adhesive tape, a PET film having a thickness of 25 μm (“LUMIRROR S-10”, produced by Toray Industries, Inc.) was bonded (for backing) to the adhesive face opposite to the measuring face.

The measuring face of the strip-shaped tape sample was then bonded to a Nomex honeycomb (width 50 mm×length 125 mm, thickness 10 mm) and the tape sample was bonded under pressure by single reciprocation with a 2-kg roller. It is then aged under an atmosphere of 23° C. and 50% RH for 0.5 hour to give a test sample.

The 180° peel test of the pressure-sensitive adhesive tape (strip-shaped tape sample) was performed by using the test sample, and the 180° peel adhesive power (to honeycomb core) of the pressure-sensitive adhesive tape to the honeycomb core (N/25 mm) was determined. Measurement was made under an atmosphere of 23° C. and 50% RH under the condition of a peel angle of 180° and a tensile speed of 300 mm/minute by using a tensile tester. In the case of a double-sided pressure-sensitive adhesive tape, the 180° peel adhesive power (to honeycomb core) of both adhesive faces was determined.

### (3) Release Force of Separator

A strip-shaped tape sample (size: width 50 mm×length 150 mm) was cut off from each of the pressure-sensitive adhesive tapes obtained in Examples and Comparative Examples. In the case of a double-sided pressure-sensitive adhesive tape, a PET film having a thickness 25 μm (“LUMIRROR S-10”, produced by Toray Industries, Inc.) was bonded (for backing) to the first face side.

The 180° peel test of separator was performed by using the strip-shaped tape sample thus obtained for determination of the release force of the separator (N/50 mm). Measurement was made under an atmosphere of 23° C. and 50% RH under the condition of a peel angle of 180° and a tensile speed of 300 mm/minute by using a tensile tester.

### (4) Holding Power

A strip-shaped tape sample (size: width 10 mm×length 100 mm) was cut off from each of the pressure-sensitive adhesive tapes obtained in Examples and Comparative Examples. In the case of a double-sided pressure-sensitive adhesive tape, a PET film having a thickness of 25 μm (“LUMIRROR S-10”, produced by Toray Industries, Inc.) was bonded (for backing) to the adhesive face opposite to the measuring face.

The measuring face (adhesive face) of the strip-shaped tape sample was then bonded to a Bakelite plate (size: width 25 mm×length 125 mm, thickness 2 mm) so as to have a bonding area of 200 mm² (size: width 10 mm×length 20 mm). The tape sample was then bonded under pressure by single reciprocation of a 2-kg roller and aged under an atmosphere of 40° C. and 50% RH for 0.5 hour to give a test sample.

The holding power of the pressure-sensitive adhesive tape was determined (according to JIS Z 0237) by using the test sample. The holding power was evaluated by measuring the distance of the pressure-sensitive adhesive tape dislocated form the original bonding position (mm) (displacement distance) when a tensile load of 9.8 N was applied to one end of the pressure-sensitive adhesive tape for 1 hour in a state where the Bakelite plate is fixed under an atmosphere of 40° C. and 50% RH by using a holding power tester. In the case of a double-sided pressure-sensitive adhesive tape, the displacement distance of both adhesive faces (first and second face sides) was determined.

### (5) Breaking Strength

A dumbbell-shaped No. 2 test sample was cut off from each of the pressure-sensitive adhesive tapes obtained in Examples and Comparative Examples for the tensile test. The breaking strength (N/10 mm) was evaluated by measuring the load at breakage when the test sample with a marked line distance (initial length) of 10 mm is pulled at a tensile speed of 100 min/minute under an atmosphere of 23° C. and 50% RH by using a tensile tester. The number of tests (n) was three and the average was calculated. The breaking strength was determined both in the machine direction (MD) and in the transverse direction (TD) of the pressure-sensitive adhesive tape.

### (6) Cleavage Adhesive Strength

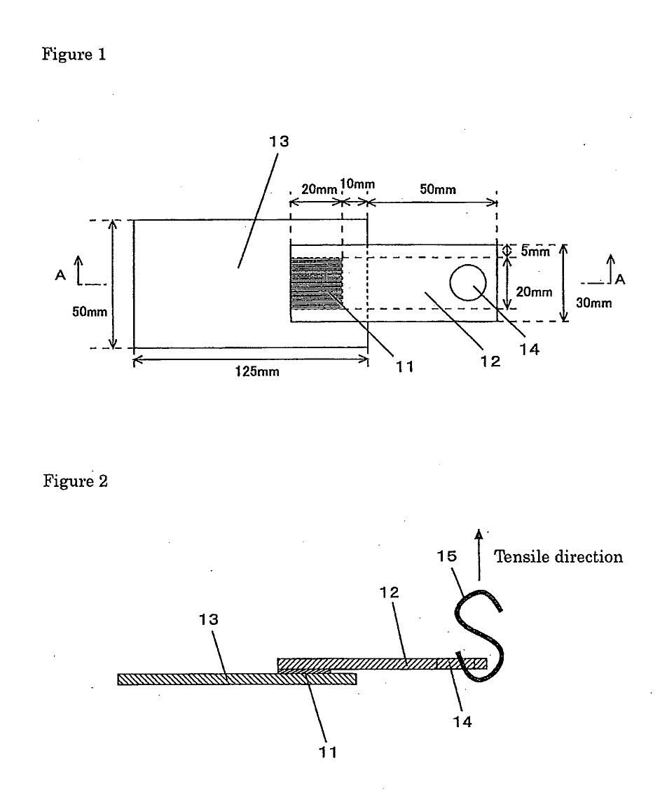

FIG. 1 is an explanatory diagram (top view) illustrating the test sample used in measurement of cleavage adhesive strength. FIG. 2 is an explanatory diagram (A-A cross-sectional view) illustrating the test sample hooked with an S-shaped hook, used in measurement of the cleavage adhesive strength.

A tape sample 11 (size: 20 mm×20 mm, area: 400 mm²) was cut off from each of the pressure-sensitive adhesive tapes obtained in Examples and Comparative Examples and used in measurement.

A SUS plate (a) 12 (size: width 30 mm×length 80 mm, thickness 2.0 mm) and a SUS plate (b) 13 (size: width 50 mm×length 125 mm, thickness 2.0 mm) were bonded to each other via the tape sample 11, as will be described below, to give a test sample shown in FIGS. 1 and 2. Specifically, in the case of a double-sided pressure-sensitive adhesive tape, the first face side of the tape sample 11 was bonded to a SUS plate (a) 12 having a hole 14 at the end in the longitudinal direction and the adhesive face of the second face side thereof to a SUS plate (b) 13. Alternatively in the case of a single-sided pressure-sensitive adhesive tape, the base face of tape sample 11 is bonded (for fixation) to a SUS plate (b) 13 by using an adhesive (“Instant Adhesive”, produced by DCM Japan Co., Ltd.) and the adhesive face of tape sample 11 to a SUS plate (a) 12. The tape sample 11 was then bonded under pressure by single reciprocation of a 5-kg roller and aged under an atmosphere of 23° C. and 50% RH for 0.5 hour to give a test sample.

The end of the SUS plate (b) 13 was fixed with a jig for 90° peel test for horizontal placement of the test sample. As shown in FIG. 2, a S-shaped hook 15 was hooked in the hole 14 at the end of the SUS plate (a) 12. Then, the maximum load when the pressure-sensitive adhesive tape (tape sample 11) was peeled off, as the S-shaped hook 15 was pulled at a speed of 300 mm/minute in the direction perpendicular to the surface of the SUS plate (b) 13 (tensile direction shown in FIG. 2) under an atmosphere of 23° C. and 50% RH, was determined by using a tensile tester, and used as the cleavage adhesive strength (N/400 mm²). The number of tests (n) was three and the maximum value was used.

### (7) Shear Adhesive Strength

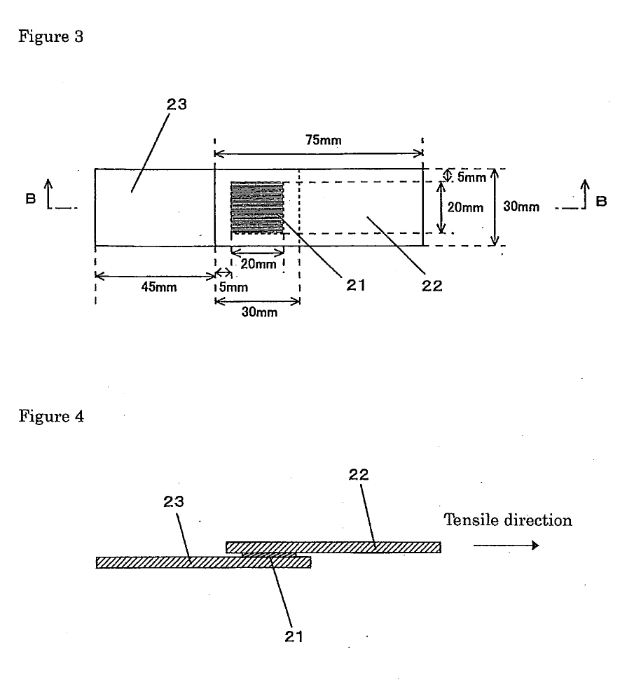

FIG. 3 is an explanatory diagram (top view) illustrating the test sample used in the shear adhesive strength measurement. FIG. 4 is explanatory diagram (B-B cross-sectional view) illustrating the test sample used in shear adhesive strength measurement.

A tape sample 21 (size: 20 mm×20 mm, area: 400 mm²) was cut off from each of the pressure-sensitive adhesive tapes obtained in Examples and Comparative Examples. Subsequently as shown in FIGS. 3 and 4, a test plate 22 (SUS304 plate, size: width 30 mm×length 75 mm×thickness 0.1 mm) and a test plate 23 (SUS304 plate, size: width 30 mm×length 76 mm×thickness 0.1 mm) were bonded to each other via the tape sample 21. In the case of a single-sided pressure-sensitive adhesive tape, the test plates 22 and 23 were bonded to each other as the base face (face opposite to adhesive face) was bonded (for fixation) to one test plate by using an adhesive (“Instant Adhesive”, produced by DCM Japan Co., Ltd.). The tape sample 21 was then bonded under pressure by single reciprocation of a 5-kg roller and aged under an atmosphere of 23° C. and 50% RH for 0.5 hour to give a test sample.

One end of the test sample was fixed and the other end was held and pulled in the direction shown in FIG. 4 at a tensile speed of 50 mm/minute under an atmosphere of 23° C. and 50% RH by using a tensile tester. The load when the pressure-sensitive adhesive tape (tape sample 21) was peeled off was determined as the shear adhesive strength (N/400 mm²). The number of tests (n) was three and the maximum value was used.

### (8) Honeycomb Cutting Operability

A honeycomb core was fixed on the table of an operating machine by using each of the pressure-sensitive adhesive tapes obtained in Examples and Comparative Examples for cutting operation of the honeycomb core. In the case of a double-sided pressure-sensitive adhesive tape, a honeycomb core was fixed on the table of a operating machine by bonding the honeycomb core to one adhesive face (the surface of the thicker pressure-sensitive adhesive layer if the thicknesses of the pressure-sensitive adhesive layers on both faces are different, and the surface of any pressure-sensitive adhesive layer without differentiation if the thicknesses of the pressure-sensitive adhesive layers are the same) and a PET film having a thickness of 38 μm to the other adhesive face, and adsorbing the PET film side thereof on the table of a operating machine under vacuum. In the case of a single-sided pressure-sensitive adhesive tape, the honeycomb core was fixed on the table of an operating machine by bonding the honeycomb core to the adhesive face and the base (PET base) side on the table of the operating machine under vacuum.

The honeycomb core fixed on the operating machine as described above was machine-operated for 30 minutes, and fixing property during cutting operation (e.g., absence of dislocation or separation of the honeycomb core during cutting operation) and peeling property (absence of fracture of the honeycomb core or adhesive deposit, when the pressure-sensitive adhesive tape was peeled off) after cutting operation were evaluated. The honeycomb cutting operability (cutting operability of honeycomb cores) was evaluated according to the following criteria:

Favorable (◯): when there is no problem in both properties, and

Unfavorable (x): when there are problems in either one of the properties.

TABLE 1

| | | | | Example 1 | Example 2 | Example 3 | Example 4 | Example 5 |
|---|---|---|---|---|---|---|---|---|
| Configuration of | Double-sided pressure-sensitive adhesive tape/ | | | Double- | Double- | Single- | Single- | Double- |
| pressure- | Single-sided pressure-sensitive adhesive tape | | | sided | sided | sided | sided | sided |
| sensitive | Thickness of pressure- | First face side | (μm) | 125 | 50 | 250 | 125 | 250 |
| adhesive tape | sensitive | Second face side | (μm) | 50 | 125 | — | — | 250 |
| | adhesive layer | | | | | | | |
| | Base | Kind of base | | PET | PET | PET | PET | PET |
| | | Thickness | (μm) | 38 | 38 | 38 | 38 | 38 |
| | Thickness of entire tape | | (μm) | 213 | 213 | 290 | 163 | 540 |
| 180° Peel adhesive power (to SUS) | | First face side | (N/20 mm) | 15.5 | 10.2 | 21.1 | 15.4 | 13.2 |
| | | Second face side | (N/20 mm) | 10.2 | 15.2 | — | — | 15.0 |
| 180° Peel adhesive power (to honeycomb core) | | First face side | (N/25 mm) | 2.5 | 2.1 | 1.4 | 1.1 | 4.4 |
| | | Second face side | (N/25 mm) | 1.8 | 2.9 | — | — | 4.5 |
| Release force of separator | | | (N/50 mm) | 0.73 | 1.01 | 0.42 | 0.34 | 1.00 |
| Holding power (dislocation distance) | | First face side | (mm) | 0.1 | 0.1 | 0.1 | 0.1 | 0.1 |
| (to Bakelite plate, 40° C. × 9.8 N × 1 hour) | | Second face side | (mm) | 0.1 | 0.1 | — | — | 0.1 |
| Breaking strength (tensile speed: 100 mm/min) | | MD | (N/10 mm) | 62 | 67 | 60 | 51 | 67 |
| | | TD | (N/10 mm) | 64 | 54 | 71 | 63 | 66 |
| Shear adhesive strength (tensile speed: 50 mm/min) | | | (N/400 mm²) | 510 | 580 | 290 | 280 | 220 |
| Cleavage adhesive strength (tensile speed: 300 mm/min) | | | (N/400 mm²) | 40 | 42 | 17 | 20 | 41 |
| Honeycomb cutting operability | | | | ∘ | ∘ | ∘ | ∘ | ∘ |
| | | | | | | Compar- | Compar- | Compar- |
| | | | | | | ative | ative | ative |
| | | | | Example 6 | Example 7 | Example 1 | Example 2 | Example 3 |
| Configuration of | Double-sided pressure-sensitive adhesive tape/ | | | Double- | Double- | Double- | Double- | Double- |
| pressure- | Single-sided pressure-sensitive adhesive tape | | | sided | sided | sided | sided | sided |
| sensitive | Thickness of pressure- | First face side | (μm) | 300 | 250 | 4 | 42 | 66 |
| adhesive tape | sensitive | Second face side | (μm) | 300 | 250 | 4 | 42 | 66 |
| | adhesive layer | | | | | | | |

| | | | | | | |
|---|---|---|---|---|---|---|
| Base | Kind of base | PET | PET | PET | Nonwoven | Nonwoven |
| | | | | | fabric | fabric |

| | | | | | | |
|---|---|---|---|---|---|---|
| Thickness | (μm) | 38 | 25 | 2 | 76 | 38 |

| | | | | | | |
|---|---|---|---|---|---|---|
| Thickness of entire tape | (μm) | 640 | 525 | 10 | 160 | 170 |

| 180° Peel adhesive power (to SUS) | First face side | (N/20 mm) | 14.5 | 13.4 | 4.7 | 16.1 | 12.8 |
|---|---|---|---|---|---|---|---|
| | Second face side | (N/20 mm) | 14.0 | 13.1 | 6.1 | 18.1 | 15.2 |
| 180° Peel adhesive power (to honeycomb core) | First face side | (N/25 mm) | 5.0 | 4.8 | 0.02 | 2.3 | 2.0 |
| | Second face side | (N/25 mm) | 5.4 | 5.2 | 0.03 | 2.3 | 2.3 |
| Release force of separator | | (N/50 mm) | 0.98 | 0.97 | 0.15 | 0.34 | 0.31 |
| Holding power (dislocation distance) | First face side | (mm) | 0.1 | 0.1 | 0.2 | 0.7 | 0.4 |
| (to Bakelite plate, 40° C. × 9.8 N × 1 hour) | Second face side | (mm) | 0.1 | 0.1 | 0.4 | 0.7 | 0.4 |
| Breaking strength (tensile speed: 100 mm/min) | MD | (N/10 mm) | 65 | 51 | 2 | 21 | 15 |
| | TD | (N/10 mm) | 64 | 48 | 2 | 21 | 5 |

| | | | | | | |
|---|---|---|---|---|---|---|
| Shear adhesive strength (tensile speed: 50 mm/min) | (N/400 mm²) | 300 | 280 | 450 | 450 | 390 |
| Cleavage adhesive strength (tensile speed: 300 mm/min) | (N/400 mm²) | 31 | 42 | 19 | 31 | 26 |

| | | | | | |
|---|---|---|---|---|---|
| Honeycomb cutting operability | ∘ | ∘ | x | x | x |

As obvious from the results in Table 1, the pressure-sensitive adhesive tapes according to the present invention (in Examples) had superior honeycomb cutting operability (favorable honeycomb cutting operability). On the other hand, the honeycomb cutting operability was unfavorable, when the breaking strength was too low (Comparative Examples).

### REFERENCE SIGNS LIST

11: Pressure-sensitive adhesive tape (tape sample)
12: SUS plate (a)
13: SUS plate (b)
14: Hole
15: S-shaped hook
21: Pressure-sensitive adhesive tape (tape sample)
22: Test plate (SUS304 plate)
23: Test plate (SUS304 plate)

1. A pressure-sensitive adhesive tape for fixing a honeycomb core during cutting operation comprising:
a base; and
a pressure-sensitive adhesive layer formed on at least one face of the base;
and having:
a cleavage adhesive strength of 10 to 80 N/400 mm² measured by the following cleavage adhesive strength test;
a shear adhesive strength of 100 to 700 N/400 mm²;
a breaking strength in the machine direction (MD) of 30 to 200 N/10 mm; and
a breaking strength in the transverse direction (TD) of 30 to 200 N/10 mm;
cleavage adhesive strength test: a surface of the pressure-sensitive adhesive layer of a pressure-sensitive adhesive tape (size: 20 mm×20 mm, area 400 mm²) is bonded to an end of a SUS plate (a) (size: width 30 mm×length 80 mm, thickness: 2.0 mm) in the longitudinal direction, and the opposite face side of the pressure-sensitive adhesive tape to the side bonded to the SUS plate (a) is fixed to a SUS plate (b), to give a test sample; the load applied when the pressure-sensitive adhesive tape is peeled off is determined, as the SUS plate (b) is fixed and an end of the SUS plate (a) in the longitudinal direction opposite to that bonded to the pressure-sensitive adhesive tape is pulled in a direction perpendicular to the surface of the SUS plate (b) at a speed of 300 mm/minute.

2. The pressure-sensitive adhesive tape for fixing a honeycomb core during cutting operation according to claim 1, wherein the base is a plastic film.

3. The pressure-sensitive adhesive tape for fixing a honeycomb core during cutting operation according to claim 1, wherein an adhesive forming the pressure-sensitive adhesive layer is an acrylic adhesive.

4. The pressure-sensitive adhesive tape for fixing a honeycomb core during cutting operation according to claim 1, wherein the pressure-sensitive adhesive layer is a pressure-sensitive adhesive layer formed by irradiation of active energy ray.
